(19) United States
(12) Patent Application Publication
(10) Pub. No.: US 2018/0176450 A1
(43) Pub. Date: Jun. 21, 2018

(54) IMAGE PROCESSING DEVICE

(71) Applicant: LG INNOTEK CO., LTD., Seoul (KR)

(72) Inventor: Ki Kyung Jeon, Seoul (KR)

(21) Appl. No.: 15/736,884

(22) PCT Filed: Aug. 8, 2016
(86) PCT No.: PCT/KR2016/008704

§ 371 Date: Dec. 15, 2017

(30) Foreign Application Priority Data
Aug. 6, 2015 (KR) 10-2015-0111249

(51) Int. Cl. H04N 5/232; H04N 9/04; G06T 7/215; H04N 5/225; G02B 7/09

(52) U.S. Cl. CPC H04N 5/23209; H04N 9/045; G06T 7/215; G06T 2207/10016; H04N 5/23212; G02B 7/09; H04N 5/2257

(57) ABSTRACT

The present invention relates to an image processing device including a lens module, an image sensor for converting an optical signal inputted through the lens module into an image signal, a sensing sensor for sensing a target object, and an image processing module for receiving the image signal and a result of sensing the target object and correcting the image signal if the target object is not in a preset center range.

### TECHNICAL FIELD

The present invention relates to an image processing device including a lens module, an image sensor for converting an optical signal inputted through the lens module into an image signal, a motion sensor for sensing a target object, and an image processing module for receiving the image signal and a result of sensing the target object and correcting the image signal if the target object is not in a preset center range.

### BACKGROUND ART

A lens module provided in a camera is used in most of electronic devices used in the modern society, such as a CCTV, an in-home display of a door bell or the like, a smart terminal, a computer device and the like. Particularly, a technique of widely applying the lens module to a digital camera, a computer image device and the like using an image sensor for converting an optical signal into an electrical image signal if the optical signal enters through the lens module is studied widely.

If a target object photographed by the lens module is placed at one side, i.e., on the upper, lower, left or right side, not at the center of a camera, a method of performing Pan, Tilt and Zoom (PTZ) by sensing the target object and mechanically changing the camera itself is used recently.

However, since a method of manually adjusting a lens module of a camera or adjusting the lens module using a motor or the like further includes a mechanical configuration (a motor, a device for coupling the motor and the camera, and the like), the volume grows excessively large, and the price increases high. Therefore, a method of developing an image processing device for correcting an image signal to place a target object at the center through image signal processing without an additional mechanical configuration is studied diversely.

### DISCLOSURE OF INVENTION

### Technical Problem

Therefore, the present invention has been made in view of the above problems of an existing image processing device, and it is an object of the present invention to provide an image processing device, in which if an image sensor converts an optical signal into an image signal, a sensor senses a target object, analyzes its position and performs digital PTZ to adjust the image signal to place the target object at the center.

In addition, another object of the present invention is to provide an image processing device further including a sound sensor, as well as a motion sensor, to further increase accuracy by obtaining area information through the motion sensor and position information through the sound sensor and using both of the obtained information.

In addition, still another object of the present invention is to provide an image processing device further including a distance measurement module for adjusting a resolution according to a distance and grasping an accurate position of a target object.

The technical objects to be accomplished by the present invention are not limited to the technical objects mentioned above, and various technical objects may be included within a scope apparent to those skilled in the art.

### Technical Solution

To accomplish the above objects, according to one aspect of the present invention, there is provided an image processing device including: a lens module; an image sensor for converting an optical signal inputted through the lens module into an image signal; a sensing sensor for sensing a target object; and an image processing module for receiving the image signal and a result of sensing the target object and correcting the image signal if the target object is not in a preset center range.

In addition, in the image processing device according to an embodiment of the present invention, the image processing module performs digital Pan, Tilt and Zoom (PTZ) at a specific angle using an Image Signal Processing (ISP) method.

In addition, in the image processing device according to an embodiment of the present invention, if the target object is not in a preset center range, the image processing module corrects the image signal by setting again a predetermined area around the target object as a center range. At this point, when the image signal is corrected, the image processing module corrects a predetermined area around the target object to be enlarged or moves a predetermined area around the target object to the center.

Meanwhile, in the image processing device according to an embodiment of the present invention, the sensing sensor is a Passive Infrared Ray (PIR) sensor, i.e., a motion sensor, and the motion sensor senses the target object according to temperature change of the target object.

In addition, in the image processing device according to an embodiment of the present invention, the motion sensor senses the target object according to a preset sensing angle, and the motion sensor processes information on a target object deviating from the sensing angle as a noise and senses the target object by adjusting the sensing angle.

In addition, in the image processing device according to an embodiment of the present invention, the motion sensor is provided in plurality, and the plurality of motion sensors is placed on the upper and lower sides, on the left and right sides, or on the upper, lower, left and right sides of the lens module.

At this point, in the image processing device according to an embodiment of the present invention, when the plurality of motion sensors commonly senses a target object, the image processing module corrects the image signal by setting again an intermediate range of the motion sensors sensing the target object as a sensing angle.

Meanwhile, in the image processing device according to an embodiment of the present invention, the sensing sensor is a sound sensor for sensing sound information of the target object.

In addition, in the image processing device according to an embodiment of the present invention, the image processing module receives the sound information and corrects the image signal if the target object is not in a preset center range.

In addition, in the image processing device according to an embodiment of the present invention, the sound sensor is provided in plurality, and the image processing device receives sound information sensed by the plurality of sound sensors and measures a position of the target object according to a difference between frequencies of the sound information.

At this point, in the image processing device according to an embodiment of the present invention, if the target object is not in a preset center range, the image processing module corrects the image signal by setting again a predetermined area around the target object as a center range. In addition, each of the plurality of sound sensors senses sound information according to a preset sensing angle and processes sound information deviating from the sensing angle as a noise.

Meanwhile, the image processing device according to an embodiment of the present invention further includes a distance measurement module for measuring distance information of the target object. At this point, the distance measurement module includes: an operational amplifier; and a variable resistor connected between any one of input terminals of the operational amplifier and an output terminal, wherein the distance measurement module measures the distance information of the target object by adjusting a gain of the operational amplifier through adjustment of the variable resistor.

Meanwhile, the image processing device according to an embodiment of the present invention further includes a communication unit for transmitting the image signal corrected by the image processing module to a display device, wherein the display device is included in at least any one of a smart terminal, an in-home display and a computer device.

In addition, in the image processing device according to an embodiment of the present invention, the sensing sensor repeats on and off according to a preset cycle when the lens module is in an off state, and the lens module is switched to an on state if the sensing sensor senses a target object.

Meanwhile, an image processing method of an image processing device according to another aspect of the present invention includes the steps of: sensing a target object, by a sensing sensor; converting an optical signal inputted through a lens module into an image signal, by an image sensor; receiving the image signal and a result of sensing the target object and correcting the image signal if the target object is not in a preset center range, by an image processing module; and outputting the corrected image signal, by a display device.

### Advantageous Effects

In the image processing device of the present invention, an image sensor converts an optical signal into an image signal, and a sensor senses a target object, analyzes its position, and performs digital PTZ to adjust the image signal to place the target object at the center, and thus the target object may be confirmed at the center at all times although the target object is positioned at any place in front of the lens module.

In addition, although volume of a conventional camera is excessively large and its price is high since the camera further includes a mechanical configuration (a motor, a device for coupling the motor and the camera, and the like) to manually adjust a lens module or adjust the lens module using a motor or the like, a product of the present invention may be miniaturized and light-weighted since an output screen of a target object is adjusted through image processing without an additional mechanical configuration.

In addition, since the image processing device of the present invention further includes a sound sensor, as well as a motion sensor, accuracy may be further increased by obtaining area information through the motion sensor and position information through the sound sensor and using both of the obtained information.

In addition, since the image processing device of the present invention further includes a distance measurement module, a resolution may be adjusted according to a distance, and an accurate position of a target object may be grasped.

### BRIEF DESCRIPTION OF THE DRAWINGS

FIGS. 1a and 1b are views showing the configuration of an image processing device according to an embodiment of the present invention.

FIGS. 2a, 2b, 2c and 2d are exemplary views showing a method of sensing a target object by a motion sensor or a sound sensor of an image processing device according to an embodiment of the present invention.

FIGS. 3a, 3b and 3c are views showing the configuration of an image processing device including a lens module, a motion sensor and a sound sensor according to an embodiment of the present invention.

FIGS. 4a, 4b and 4c are exemplary views showing a method of correcting an image signal by an image processing device according to an embodiment of the present invention.

FIGS. 5a and 5b are exemplary views showing a method of correcting an image signal by an image processing module of an image processing device according to an embodiment of the present invention.

FIG. 6 is an exemplary view showing a method of sensing a target object by a sound sensor of an image processing device according to an embodiment of the present invention.

FIG. 7 is a circuit diagram showing the configuration of a distance measurement module of an image processing device according to an embodiment of the present invention.

FIG. 8 is a flowchart illustrating an image processing method of an image processing device according to an embodiment of the present invention.

### DESCRIPTION OF SYMBOLS

100: Image processing device
110: Lens module
120: Image sensor
130, 131, 132, 133, 134, 135, 136, 137: Motion sensor
140, 141, 142, 143, 144, 145, 146, 147, 148, 149: Sound sensor
150: Distance measurement module
151: Operational amplifier
152: Variable resistor
160: Image processing module
170: Communication unit
180, 181, 182, 183, 184, 185, 186, 187: Target object
190, 191, 192, 193, 194: Sensor setting angle
200: Display device
210: Display area
211: Display area around target object
212, 213: Display area of corrected image signal
214: Cut-off display area

### BEST MODE FOR CARRYING OUT THE INVENTION

Hereinafter, an ‘image processing device’ according to the present invention will be described in detail with reference to the accompanying drawings. The disclosed embodiments are provided to enable those skilled in the art to easily understand the scope of the present invention, and the present invention is not limited by such embodiments. Moreover, matters illustrated in the drawings are schematized in order to describe or explain the embodiments of the present invention more easily and hence may be different from actually embodied forms.

Meanwhile, the constitutional components expressed below are merely examples for implementing the present invention. Accordingly, other constitutional components may be used in other implementations of the present invention without departing from the spirit and scope of the present invention.

In addition, the expression of ‘including’ a component is an expression of an ‘open type’ which merely refers to existence of a corresponding component, and it should not be construed as precluding additional components.

In addition, the expressions such as ‘first’, ‘second’ and the like are expressions used only to distinguish a plurality of constitutions and do not limit the sequence or other features of the constitutions.

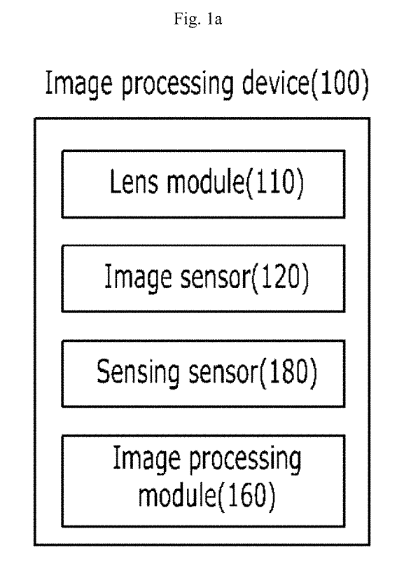

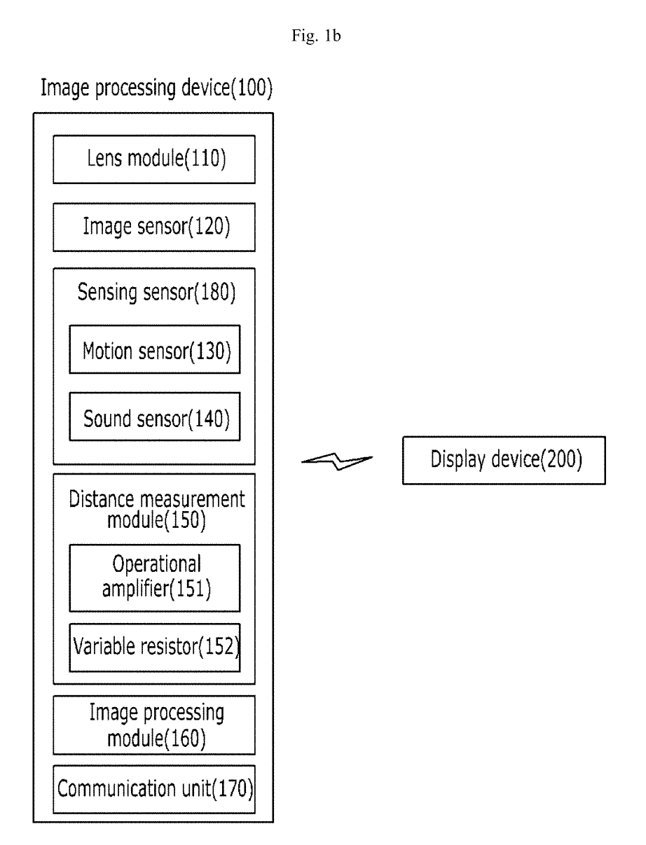

FIGS. 1a and 1b are views showing the configuration of an image processing device according to an embodiment of the present invention.

Referring to FIG. 1a, an image processing device 100 of the present invention may include a lens module 110, an image sensor 120, a sensing sensor 180 and an image processing module 160.

The image sensor converts an optical signal inputted through the lens module into an image signal, and if the sensing sensor senses a target object, the image processing module receives a result of sensing the target object and corrects the image signal if the target object is not in a preset center range.

At this point, the sensing sensor may be implemented as a motion sensor 130, a sound sensor 140 or both the motion sensor 130 and the sound sensor 140. For example, the image processing device may correct an image signal after the motion sensor senses a motion of a target object, or the image processing device may correct an image signal after the sound sensor senses sound information of a target object. In the same manner, both the motion sensor and the sound sensor may be used for sensing a target object to further accurately confirm information on the position and distance of a target object.

FIG. 1b is a view showing the detail configuration of the image processing device of FIG. 1a. Referring to FIG. 1b, an image processing device 100 of the present invention may include a lens module 110, an image sensor 120, a motion sensor 130, a sound sensor 140, a distance measurement module 150, an image processing module 160 and a communication unit 170.

The lens module 110 photographs a target object within a predetermined range from the installed position, and all the lenses that can be used in a camera, such as a convex lens, a concave lens, a cylinder lens, a Fresnel lens or the like, may be used. Particularly, a wide angle lens may be used as the lens module 110, and the wide angle lens may capture a wider range although it photographs a target object at the same distance since its focal distance is shorter than that of a general lens.

The image sensor 120 converts an optical signal inputted through the lens module into an image signal. The image sensor corresponds to a configuration generally used in a digital camera or the like and performs a function of converting light entering through a camera lens, i.e., information on a photographed image, into digital information, which is an electrical signal.

In addition, the lens module 110 and the motion sensor 130 of the image processing device 100 of the present invention may be switched to on and off states. At this point, when the camera lens module is in an off state, the motion sensor repeats on and off according to a preset cycle, and when the motion sensor senses a target object while being in an on state, the lens module may be switched to the on state.

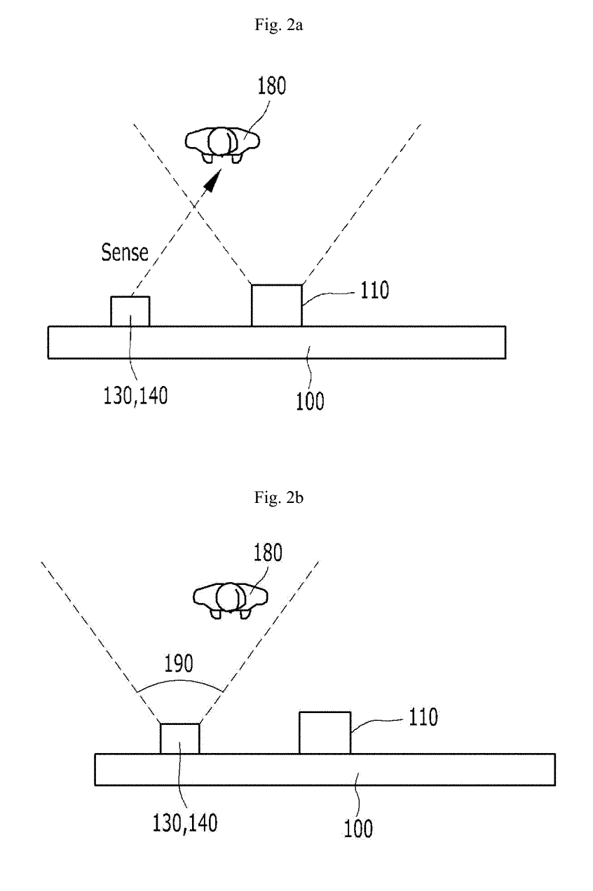

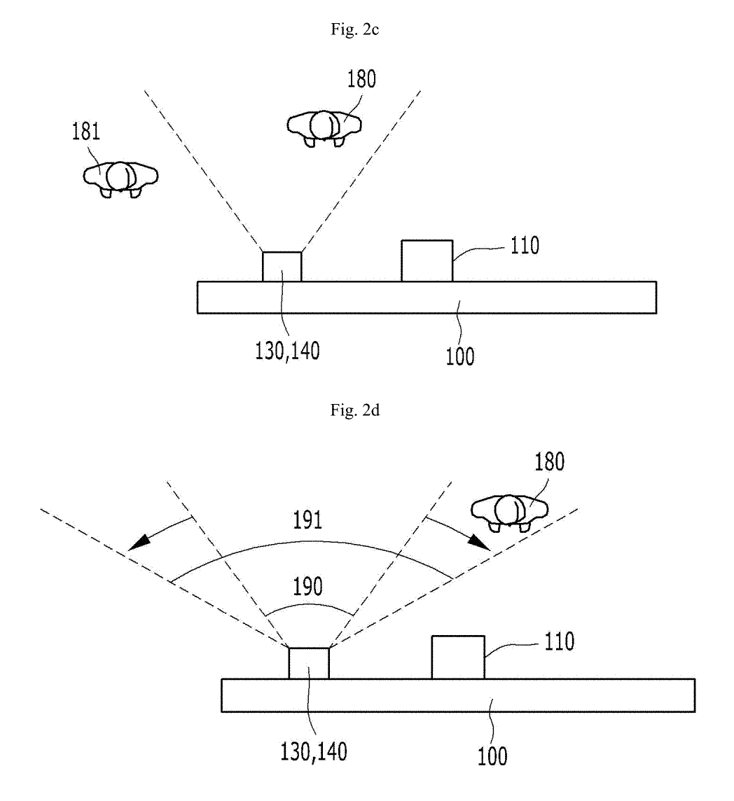

The motion sensor 130 may sense a target object 180 as shown in FIG. 2a, and all forms of sensors capable of sensing movement of a target object, such as a geomagnetic sensor, an acceleration sensor, an altimeter, a gyro sensor and the like, may be used.

At this point, a passive infrared ray (PIR) sensor may be used as the motion sensor, and it may be implemented in a method of sensing a target object by the motion sensor according to temperature change of the target object. Particularly, when the target object is a human being, a temperature of 36.5 degrees, which is the body temperature of a human being, may be set and used. When there is no one in front of the lens module, the temperature is not greatly different from the ambient temperature. However, if there is a person in front of the lens module, the temperature is comparatively higher than the ambient temperature, and infrared rays of a certain amount are emitted. Accordingly, the PIR sensor may sense the infrared rays emitted from a moving object of around 36.5 degrees.

In addition, when a PIR sensor is used, a Fresnel lens may be used in the lens module. The Fresnel lens may be implemented to have a thin area around the center of the lens by splitting the lens into a plurality of circular band shape lenses in order to reduce thickness of the lens. If such a Fresnel lens is used together with the PIR sensor, a sensing distance may be maximized, and sensitivity may be improved.

Meanwhile, referring to FIG. 2b, the motion sensor 130 may sense a target object 180 according to a preset sensing angle 190. At this point, the motion sensor of the present invention may process information on a target object 181 deviating from the sensing angle 190 as shown in FIG. 2c as a noise and transmit the information to the image processing module. In addition, the motion sensor of the present invention may sense the target object 180 by adjusting the sensing angle 190 of the motion sensor 130 to a wider angle 191.

In addition, a plurality of motion sensors may be used as the motion sensor 130. At this point, the motion sensors may be placed on the upper and lower sides 131 and 132, on the left and right sides 133 and 134, or on the upper, lower, left and right sides of the lens module 110, may be placed in a diagonal direction 135, or may be placed at any relevant locations capable of sensing the target object.

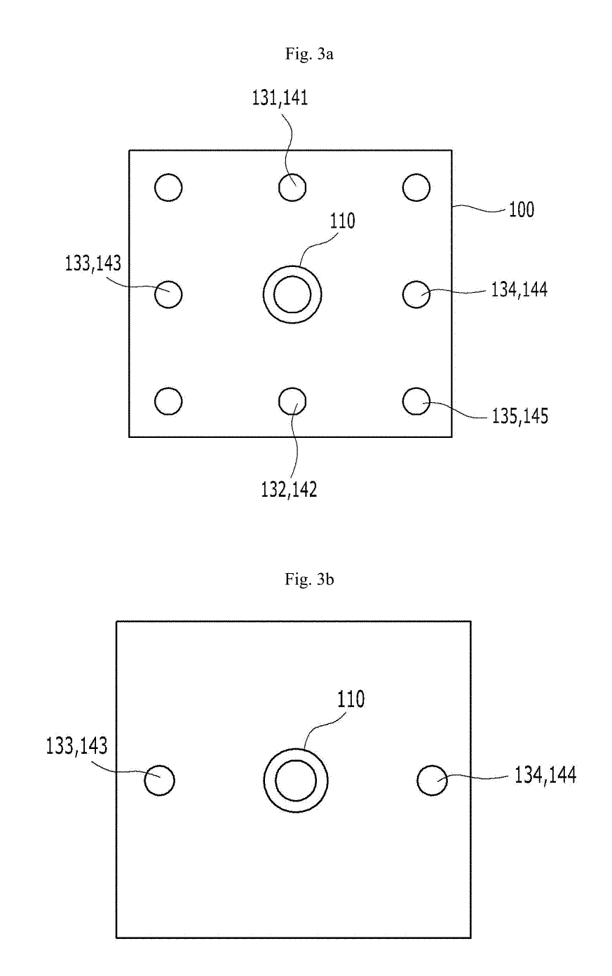

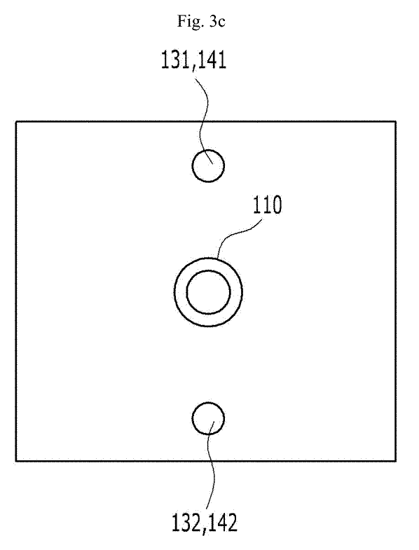

At this point, two motion sensors may be included, and the motion sensors 133 and 134 may be horizontally arranged as shown in FIG. 3b to accurately correct the horizontal position of the target object, or the motion sensors 131 and 132 may be vertically arranged as shown in FIG. 3c to accurately correct the vertical position of the target object.

The image processing module 160 receives the image signal and a result of sensing the target object and correct the image signal if the target object is not in a preset center range. At this point, the image processing module may perform digital Pan, Tilt and Zoom (PTZ) at a specific angle using an Image Signal Processing (ISP) method.

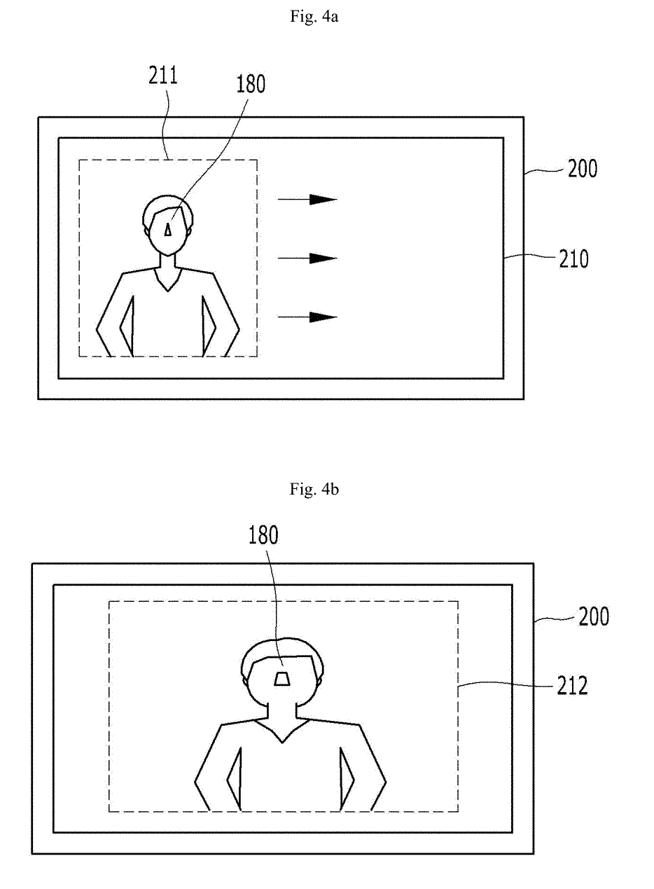

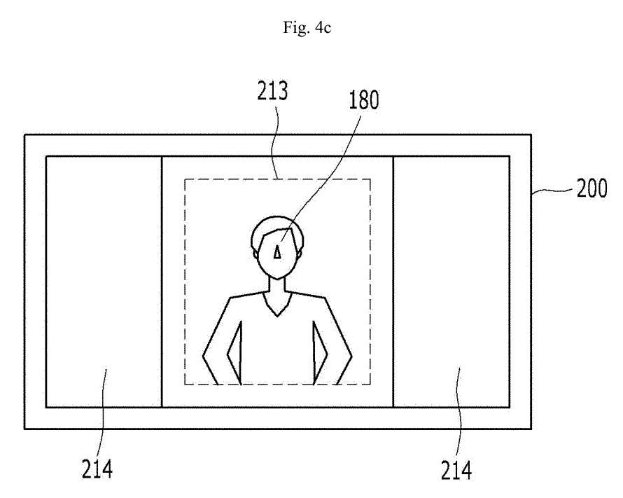

Referring to FIG. 4a, a correction method of the image processing module of the present invention for a corrected image signal, which can be implemented in a display device 200, is shown. If a display area 210 for displaying an image signal outputted by the display device 200 is physically formed, the target object 180 may appear in various directions, i.e., at the center or on the left, right, upper or lower side of the display area. At this point, if the target object does not appear at the center of a preset display area, the target object 180 is corrected, and a predetermined portion of a display area 211 around the target object 180 may be set and corrected.

In addition, if the target object is not in a preset center range, the image processing module may set again the predetermined area 211 around the target object as the center range and correct the image signal. At this point, the predetermined area 211 at a side of various directions, such as the left, right, upper or lower side, may be corrected to be positioned at the center, and when the image signal is corrected as shown in FIG. 4b, a predetermined area around the target object is corrected to be enlarged, or a correction of moving a predetermined area around the target object to the center as shown in FIG. 4c may be performed.

When a predetermined area around the target object is corrected to be enlarged, the target object 180 and the surrounding area 212 may be crushed up and down or left and right according to a horizontal/vertical ratio of the display device 200 and the display area 210. In addition, when a predetermined area 213 around the target object is moved to the center, a display area 214 cutting off left and right or upper and lower portions of the display area 210 may be created. Accordingly, the image processing device of the present invention may selectively use a correction method according to selection of a user.

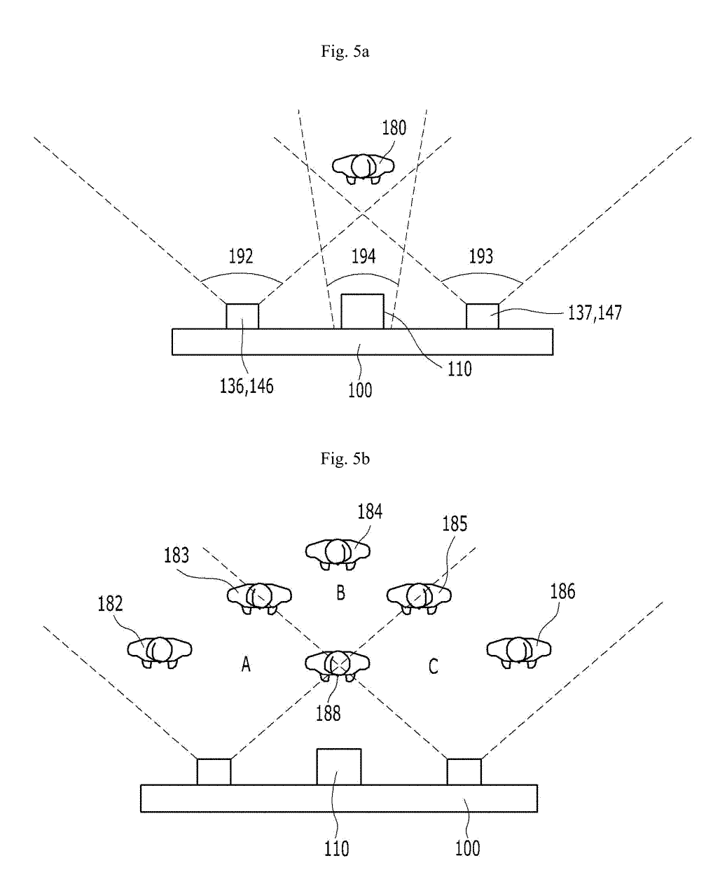

Meanwhile, when a target object is commonly sensed by a plurality of motion sensors or sound sensors, the image processing module 160 of the present invention may correct the image signal by setting again an intermediate range of the motion sensors or the sound sensors sensing the target object as a sensing angle. Referring to FIG. 5a, the target object 180 may be commonly sensed by the sensing angles 192 and 193 of a plurality of sensors 136, 137, 146 and 147. Accordingly, an intermediate range thereof may be set again as the sensing angle 194, and the image signal may be corrected on the basis of the sensing angle 194 set again.

In addition, referring to FIG. 5b, the areas sensed by a plurality of sensing sensors may be divided into A, B and C. At this point, a target object 182 sensed only in A may be determined as being positioned on the left side, a target object 184 sensed only in B may be determined as being positioned at the center, and a target object 186 sensed only in C may be determined as being positioned on the right side. In addition, a target object 183 simultaneously sensed in A and B may be determined as being positioned at the left center, and a target object 185 simultaneously sensed in B and C may be determined as being positioned at the right center.

In addition, in the case of a target object 188 simultaneously sensed in A and C, it is determined as being positioned at the center of the lens module 110, and the image processing module may correct the image signal by cutting off left and right portions and enlarging the center area as much as a preset area and display the corrected image.

Meanwhile, the image processing device 100 of the present invention may include a sound sensor 140. At this point, the sound sensor 140 senses sound information of a target object, and all forms of sensors capable of sensing sounds of the target object may be used. A microphone may be widely used as a general sound sensor.

Referring to FIG. 2b, the sound sensor 140 may sense the target object 180 according to a preset sensing angle 190. At this point, the sound sensor of the present invention may process information on a target object 181 deviating from the sensing angle 190 as shown in FIG. 2c as a noise and transmit the information to the image processing module. In addition, sound information of a target object deviating from the sensing angle is determined as a noise, and all sound information excluding the sound of the target object 180 included in the sensing angle or sound information of the target object 181 deviating from the sensing angle may be removed using a method of noise cancelling or the like. In addition, the sound sensor of the present invention may sense the target object 180 by adjusting the sensing angle 190 of the sound sensor 140 to a wider angle 191.

In addition, a plurality of sound sensors may be used as the sound sensor 140. At this point, the sound sensors may be placed on the upper and lower sides 131 and 132, on the left and right sides 133 and 134, or on the upper, lower, left and right sides of the lens module 110, may be placed in a diagonal direction 145, or may be placed at any relevant locations capable of sensing the target object.

At this point, two sound sensors may be included, and the sound sensors 143 and 144 may be arranged in the horizontal direction as shown in FIG. 3b to accurately correct the horizontal position of the target object, or the sound sensors 141 and 142 may be arranged in the vertical direction as shown in FIG. 3c to accurately correct the vertical position of the target object.

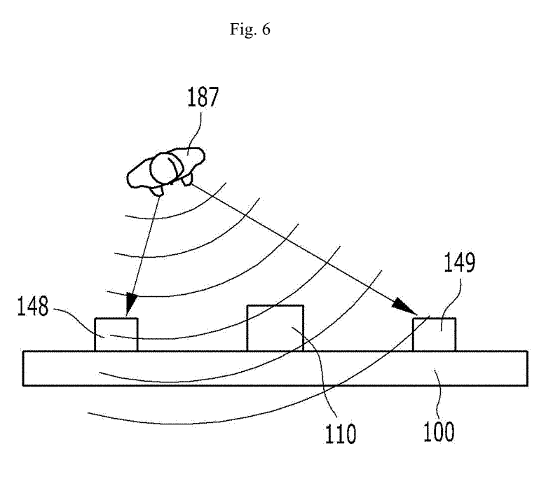

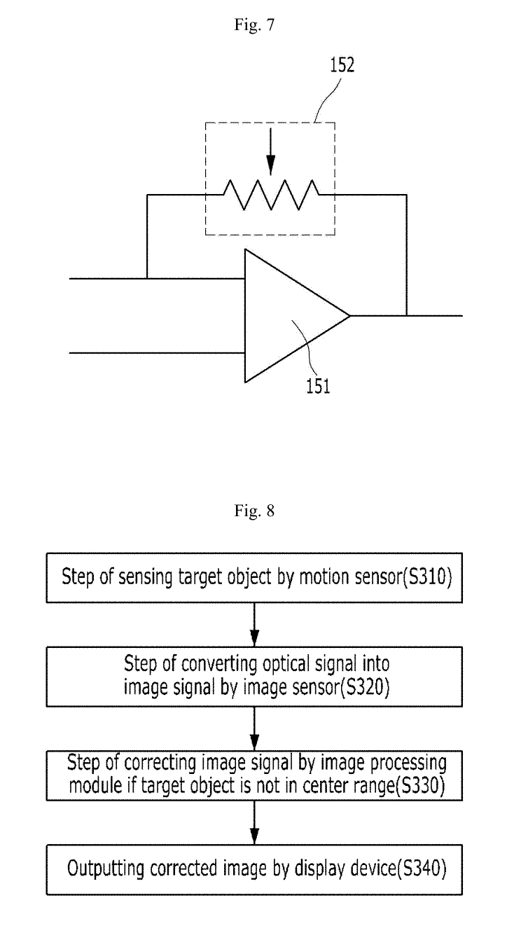

Meanwhile, referring to FIG. 6, the plurality of sound sensors 140 may receive the sensed sound information (4 the image processing device may receive the sound information sensed by the plurality of sound sensors 140) and measure a position of the target object according to the difference between the frequencies of the sound information. Since the distances between the locations of the sound sensors 148 and 149 and the target object 187 are not the same, information on the sound generated by the target object, such as the frequency, wavelength, magnitude and the like, may be different when the sound arrives at the sound sensors. Accordingly, the sound sensors may sense and analyze the difference and sense an accurate position of the target object.

In addition, the plurality of sound sensors 140 may receive the sensed sound information and confirm the position of the target object by analyzing incident angles between the target object and the sound sensors. For example, referring to FIG. 6, if the target object 187 generates a sound, the sound enters the left-side sound sensor 148 at an incident angle closed to the right angle, and the right-side sound sensor 149 senses information on a sound having an incident angle of about 45 degrees. Accordingly, the plurality of sound sensors may sense an accurate position by analyzing the sound information of the target object 187.

Meanwhile, the image processing device 100 of the present invention may use only the motion sensor 130, only the sound sensor 140 or both the motion sensor and the sound sensor to sense a target object.

For example, if the motion sensor 130 included in the image processing device 100 senses a target object, the sound sensor 140 is switched to the on state, and the sound sensor may receive information on the sound generated by the target object and measure a position of the target object according to the difference between the frequencies of the sound information. Accordingly, since the image processing device uses both the two sensors, the motion sensor 130 determines a direction and a position of the target object, and the sound sensor 140 measures a distance between the target object and the lens module, accuracy of sensing the target object is improved by using both of the information.

Meanwhile, the image processing device 100 of the present invention may further include a distance measurement module 150 for measuring information on the distance to the target object 180. At this point, all forms of devices capable of measuring the distance between the target object and the sensor may be used as the distance measurement module 150.

In addition, the distance measurement module 150 may include an operational amplifier 151 and a variable resistor 152 connected between any one of input terminals of the operational amplifier and an output terminal. Since a gain of the operational amplifier can be adjusted by adjusting the variable resistor 152 connected to the operational amplifier, a ratio of amplifying the sensitivity of the distance measurement module 150 may be adjusted.

For example, if target object A is measured when the variable resistance is five and then target object B is measured together when the variable resistance is twenty, it may be determined that target object B is farther than target object A. At this point, the image processing module may determine that a measured target object is positioned farther than a preset distance and correct the image signal to enlarge the image. In addition, the user of the image processing device 100 may conveniently adjust the sensitivity and accuracy of the sensor by adjusting the variable resistor.

The communication unit 170 transmits the image signal corrected by the image processing module 160 to the display device 200. The display device 200 may be included in at least any one of a smart terminal, an in-home display and a computer device.

At this point, the display device 200 may be implemented as an external device configured to be separate from the image processing device 100 of the present invention and transmit and receive the image signal wiredly/wirelessly through the communication unit 170, or the display device 200 and the image processing device 100 may be implemented to be integrated in one device and transmit and receive the image signal wiredly/wirelessly through the communication unit 170.

For example, the image signal corrected by the image processing module may be wiredly transmitted and received to and from an in-home display and may be transmitted and received to and from a smart terminal or a portable terminal through a wireless communication network.

Meanwhile, the image processing device of the present invention may include a lens module, an image sensor, a sensing sensor and a display device. At this point, the image sensor converts an optical signal inputted through the lens module into an image signal, and the sensing sensor senses a target object. The image processing module receives the image signal and a result of sensing the target object and corrects the image signal if the target object is not in a preset center range. In addition, the display device receives the corrected image signal from the image processing module and outputs the image signal.

FIG. 8 is a flowchart illustrating an image processing method of an image processing device according to an embodiment of the present invention. Referring to FIG. 8, an image processing method of an image processing device according to an embodiment of the present invention may include the steps of sensing a target object, by a sensing sensor (step S310), converting an optical signal into an image signal, by an image sensor (step S320), correcting the image signal, by the image processing device, if the target object is not in a preset center range (step S330), and outputting the corrected image signal, by a display device (step S340). At this point, the steps of the image processing method of the image processing device may be implemented in a reverse order within the spirit and scope of the present invention by those skilled in the art.

The embodiments of the present invention described above are disclosed for illustrative purposes, and the present invention is not limited thereto. In addition, those skilled in the art may make diverse modifications and changes within the spirit and scope of the present invention, and all the modifications and changes should be regarded as belonging to the scope of the present invention.

1. An image processing device comprising:
a lens module;
an image sensor for converting an optical signal inputted through the lens module into an image signal;
a sensing sensor for sensing a target object; and
an image processing module for receiving the image signal and a result of sensing the target object and correcting the image signal if the target object is not in a preset center range.

2. The device according to claim 1, wherein the image processing module performs digital Pan, Tilt and Zoom (PTZ) at a specific angle using an Image Signal Processing (ISP) method.

3. The device according to claim 1, wherein if the target object is not in a preset center range, the image processing module corrects the image signal by setting again a predetermined area around the target object as a center range.

4. The device according to claim 3, wherein when the image signal is corrected, the image processing module corrects a predetermined area around the target object to be enlarged.

5. The device according to claim 3, wherein when the image signal is corrected, the image processing module moves a predetermined area around the target object to a center.

6. The device according to claim 1, wherein the sensing sensor is a motion sensor.

7. The device according to claim 6, wherein the motion sensor senses the target object according to temperature change of the target object.

8. The device according to claim 6, wherein the motion sensor senses the target object according to a preset sensing angle and senses the target object by adjusting the sensing angle.

9. The device according to claim 8, wherein the motion sensor processes information on a target object deviating from the sensing angle as a noise.

10. The device according to claim 6, wherein the motion sensor is provided in plurality, and the plurality of motion sensors is placed on upper and lower sides, on left and right sides, or on upper, lower, left and right sides of the lens module.

11. The device according to claim 10, wherein when the plurality of motion sensors commonly senses a target object, the image processing module corrects the image signal by setting again an intermediate range of the motion sensors sensing the target object as a sensing angle.

12. The device according to claim 1, wherein the sensing sensor is a sound sensor for sensing sound information of the target object.

13. The device according to claim 12, wherein the sound sensor is provided in plurality, and the image processing device receives sound information sensed by the plurality of sound sensors and measures a position of the target object according to a difference between frequencies of the sound information.

14. The device according to claim 13, wherein if the target object is not in a preset center range, the image processing module corrects the image signal by setting again a predetermined area around the target object as a center range.

15. The device according to claim 13, wherein each of the plurality of sound sensors senses sound information according to a preset sensing angle and processes sound information deviating from the sensing angle as a noise.

16. The device according to claim 1, further comprising a distance measurement module for measuring distance information of the target object.

17. The device according to claim 16, wherein the distance measurement module includes:
an operational amplifier; and
a variable resistor connected between any one of input terminals of the operational amplifier and an output terminal, wherein
the distance measurement module measures the distance information of the target object by adjusting a gain of the operational amplifier through adjustment of the variable resistor.

18. The device according to claim 1, further comprising a communication unit for transmitting the image signal corrected by the image processing module to a display device, wherein
the display device is included in at least any one of a smart terminal, an in-home display and a computer device.

19. The device according to claim 1, wherein the sensing sensor repeats on and off according to a preset cycle when the lens module is in an off state, and the lens module is switched to an on state if the sensing sensor senses a target object.

20. An image processing method of an image processing device, the method comprising the steps of:
sensing a target object, by a sensing sensor;
converting an optical signal inputted through a lens module into an image signal, by an image sensor;
receiving the image signal and a result of sensing the target object and correcting the image signal if the target object is not in a preset center range, by an image processing module; and
outputting the corrected image signal, by a display device.
